(19) United States
(12) Patent Application Publication
(10) Pub. No.: US 2007/0014905 A1
(43) Pub. Date: Jan. 18, 2007

(54) Starchy material processed to produce one or more products comprising starch, ethanol, sugar syrup, oil, protein, fiber, gluten meal, and mixtures thereof

(75) Inventors: Li-Fu Chen, West Lafayette, IN (US); Qin Xu, West Lafayette, IN (US)

Correspondence Address: EDWARD J. TIMMER, P. O. BOX 770, RICHLAND, MI, 49083, US

(73) Assignee: Purdue Research Foundation

(21) Appl. No.: 11/478,345

(22) Filed: Jun. 29, 2006

Related U.S. Application Data
(63) Continuation-in-part of application No. 10/880,970, filed on Jun. 30, 2004.
(60) Provisional application No. 60/483,724, filed on Jun. 30, 2003.

(51) Int. Cl. C12G 3/08

(52) U.S. Cl. 426/490; 426/519; 426/658

(57) ABSTRACT

The invention provides a method and system of processing a starchy material that can advantageously produce ethanol, sugar syrup, or starch as the chief products along with food-grade co-products such as, but not limited to oil, protein, fiber, and gluten meal. The invention can apply such a force to a starchy material that is at a superambient temperature with a high shear processor to mill, mix, and gelatinize some of the starch. A liquefaction enzyme can be introduced into the high shear processor to liquefy the processed product. The moisture content of the processed starchy material can be reduced, which preferably occurs in the high shear processor. Some of the co-products such as the oil, protein, fiber and gluten meal can be separated prior to the sugar syrup purification or ethanol fermentation steps.

### CROSS REFERENCE TO RELATED APPLICATIONS

The present application is a continuation-in-part of the U.S. patent application Ser. No. 10/880,970 filed Jun. 30, 2004, which claims the benefits and priority of U.S. provisional application Ser. No. 60/483,724 filed Jun. 30, 2003.

### FIELD OF THE INVENTION

The present invention relates to a method and system of processing a starchy material to produce starch, ethanol, sugar syrup, oil, protein, fiber, and mixtures thereof by applying shear force to the starchy material. More particularly, the invention uses a high shear processor to mill, mix, and gelatinize some of the starch in the starchy material.

### BACKGROUND OF THE INVENTION

Corn or other starchy materials are commonly converted to nutritious products or economically valuable products like ethanol. As of February 2006, the United States had 95 ethanol plants with a total annual production capacity 4.4 billion gallons of ethanol Of these, eleven plants (12% of the ethanol plants) with individual annual plant capacity of 62 to 274 million gallons provided a total of 1.781 billion gallons of ethanol, which is approximately 40% of total US production capacity. Fifty-five ethanol plants (58% of the ethanol plants) with individual annual plant capacity of 25 to 57 million gallons provided a total of 2.315 billion gallons, which is approximately 53% of total US production capacity. The remaining 301 million gallons, which is approximately 7% of the total US production capacity, was provided by 29 plants (31% of the ethanol plants) with each having an annual capacity of less than 25 million gallons.

Wet milling and dry milling are two types of ethanol processing methods currently used in the industry. The plants with larger production capacity typically use the wet milling method. All of the plants with annual capacity of 57 million gallons or less use the dry milling method. (Sources: Renewable Fuels Association, Washington, D.C.; Nebraska Energy Office, Lincoln, Nebr.).

The wet milling method of ethanol production, as shown in FIG. 8, consists of a main process stream for ethanol production and five other branch streams for production of co-products. The main process stream produces the chief product, ethanol, and starts with steeping 801 the corn in water and sulfur dioxide. The corn is placed in large steeping tanks for 2-3 days to facilitate the separation of the corn into its components parts (i.e. germ, fiber, starch, gluten). It then proceeds in the following order: grinding and screening 802; de-germ mill 803; liquid cyclone 804 to separate the germ from a slurry containing starch, gluten, and fiber; washing 805 the slurry; grinding 806 the slurry; separating the fiber from the slurry by screening 807; separating the gluten from the starch by centrifuge 808; washing the starch with a washing filter 809 to produce starch 810; mixing the starch, water, and enzyme to form a starch mixture in a slurry tank 811; cooking the starch mixture in a jet cooker 812 to liquefy and hydrolyze the starch to a dextrose equivalent (DE) of about 5-15; placing the cooked mixture in a slurry tank 813 for further hydrolysis of the starch to form a sugar syrup; adding an enzyme to the sugar syrup for saccharification 814; adding yeast to the sugar syrup for fermentation 815; distilling 816 the fermented mixture to produce ethanol; separating water from ethanol using the molecular sieve 817; and denaturalization 818 of the ethanol.

The first branch stream of wet milling produces corn oil meal with steep liquor and proceeds in the following order after steeping 801: ultrafiltration/concentration 860 of the light steeping water, reducing the moisture of the light steeping water by evaporation 861 to produce a steep liquor, feed blending 862 the steep liquor, and reducing the moisture of the steep liquor by drying 864 to produce corn oil meal with steep liquor.

Crude corn oil is produced in the second branch stream of wet milling and proceeds from the liquid cyclone step 804 in the following order: washing and dewatering 850 of the germ, drying 851 the germ, and expeller and extraction 852 of the germ to separate corn oil meal from the crude corn oil.

The third branch stream of wet milling produces fiber. This branch stream stems from the screening 807 of the main stream and proceeds to drying 830 of the fiber.

Gluten meal is produced in the fourth branch stream and proceeds from the centrifuge 808 separation step in the following order: centrifugation and dewatering 840, and drying 841 of gluten.

The fifth branch stream of wet milling produces distiller grain. This fifth branch stems from the distillation step 816 and proceeds in the following order: centrifuge 820 separation of the solids from the sugar syrup, evaporation 821 of the liquid from the centrifuge, and using a dryer 822 to reduce the moisture from the remaining solids to produce distiller grain.

The wet milling method produces ethanol and other valuable co-products such as corn oil and starch. However, sulfur dioxide is a necessary input in the steeping process 801 and is emitted as an air pollutant in subsequent steps of the wet milling process, as shown in FIG. 8. Due to the steeping step 801, the protein in the gluten meal is not edible and can only be used for animal feed. Moreover, the steeping of the corn kernels takes several days and requires a large amount of energy and water. The wet milling method is complex and requires a very large capital investment in machinery.

Volatile organic compounds (VOC), carbon monoxide, nitrogen oxides (NOx), particulate matter (PM), sulfur dioxide (SO₂), and/or hazardous air pollutants (HAPs) are typically emitted at the evaporation, drying and/or distillation steps of the wet milling method. The air pollution emitted during the production of ethanol using the wet milling method is a serious problem. For example, in 2004 the EPA announced a Department of Justice Settlement Agreement with grain industry giant Archer Daniels Midland Company (ADM), which employs the wet milling method exclusively in its ethanol manufacturing plants. Under the settlement, ADM was required to implement sweeping environmental improvements at plants nationwide to reduce emissions. Capital improvements estimated at $213 million were needed to implement the emission reduction required by the Settlement Agreement.

The dry milling method of corn processing produces ethanol in the main stream and distiller grain in the second stream. During dry milling, the corn is ground and processed without separating the remaining various components of the grain (i.e. germ, fiber, starch and gluten). The dry milling method for producing ethanol is shown in FIG. 9 and starts with grinding the corn using a hammer mill 901, placing the ground corn and water in a slurry tank 902, and then jet steam cooking 903 the mixture with an enzyme. The rest of the main process proceeds in the following order: liquefaction of the cooked corn in a liquefaction tank 904, mash cooking 905 with an enzyme, fermentation 906 to produce a beer, distillation 907 to produce whole stillage and ethanol, molecular sieve separation 908 of water from the ethanol, and denaturalization 909 of the ethanol.

The second branch stream stems from the distillation step 907 in the following order: centrifuge separation 920 of the whole stillage into wet distiller grain and thin stillage, the moisture content of the wet distiller grain is reduced in a dryer 922, and the moisture content of the thin stillage is reduced in an evaporator 921 to produce distillers soluble. The distiller grain produced by this second branch stream can be of the “dry” type having a 10% moisture content (by weight) or of the “wet” type having a 50% moisture content (by weight). The moisture content of the distillers soluble can be reduced further in dryer 922.

Most dry milling ethanol plants produce only one co-product, distillers grain. While the dry milling method is a simpler process and requires less initial capital investment than the wet milling method, there are several disadvantages to the dry milling method. Distillers grain is made of oil, protein, and residual sugar and used for cattle feed. It has a low economic value. Distillers grain “burns” easily in the drying 922 step and generates a large quantity of VOC and PM with bad odors. Additionally, distillers grain is a perishable material that also emits a bad odor during storage.

As with the wet milling, the dry milling emits air pollution such as VOCs, carbon monoxide, NOx, and PM. These emissions are generated at several steps such as the mash cooking 905, carbon dioxide scrubber 910, and the dryer 922 steps. The EPA has strict emission limits for the dry milling process. For example, in 2002 several dry milling ethanol plants were required by the EPA to meet the restriction emission limits for NOx, PM, carbon monoxide, and hazardous air pollutants. Each plant was required to install air pollution control equipment valued at about $2 million per plant and also pay a civil penalty.

Several approaches can be taken to improve the production of starchy materials processed for food or non-food uses such as simplifying the processing method to reduce capital investment, reducing air pollutant emissions, producing food grade products, increasing the yield of products, and producing products having a high economic value.

An embodiment of the invention can produce several high value products such as, but not limited to ethanol, corn syrup, starch, zein, and oil with high levels of carotenoids. Ethanol is a major chemical that has food and industrial uses. Reformulated gasoline replaces a portion of the gasoline with small amounts of ethanol. Ethanol has a blending octane number (ON) of 110, whereas premium gasoline has an ON of 95. Ethanol is also a renewable energy source and is more expensive than gasoline.

Corn syrup and processed starch are widely used in the food industry. High fructose corn syrup is sweeter than other corn syrups containing glucose and dextrose and is the most popular sweetener produced from corn. Processed starch capable of swelling in water at a broad range of temperatures can improve the efficiency of food production and stability of the food product.

Zein, a protein fraction from corn that is prolamine in nature and is soluble in aqueous alcohols, can be used in film and fiber applications. Zein can be extracted with aqueous alcohol and dried to a granular powder; however, the isolation of zein can be expensive. Zein has the potential to become widely used; however, this potential has not been realized because zein production is too expensive to compete with nylon and polyester.

Plant oil and carotenoids are useful in a variety of industrial and edible applications. Studies in recent years have established the value of polyunsaturated fatty acids derived from corn oil as a dietary constituent. Carotenoids are useful as supplements and colorants and for oil based food products and animal feeds. In addition, carotenoids such as lutein, zeaxanthin, and beta-carotene have been shown to have health benefits. For example, lutein and zeaxanthin consumption has been associated with prevention of macular degeneration of the eye. An embodiment of the invention can provide an oil with a high level of cartenoids, where the carotenoids lutein and zeaxanthin can be in a ratio of about 2:1 to about 1:1.

The present invention provides an improved method of processing a starchy material in a high shear processor to produce one or more products that overcomes the disadvantages of traditional wet and dry milling methods.

### SUMMARY OF THE INVENTION

The invention involves a method of processing a starchy material to produce one or more products comprising starch, ethanol, sugar syrup, starch, oil, protein, fiber, and gluten meal. The starch can preferably swell in water at a subambient temperature.

The starchy material processed pursuant to the invention can be corn, sorghum, millet, rice, oat, wheat, barley, buckwheat, rye, sweet potato, potato, cassaya, starch, or mixtures thereof.

An embodiment of the invention is a method of processing the starchy material comprising the steps of introducing a starchy material and water into a high shear processor; and applying such a force to the material that is at a superambient temperature within the processor to mill, mix, and gelatinize some of the starch of the starchy material to produce a processed product. Water in the form of liquid or steam can be introduced into the processor to achieve a liquid content in the range of about 20% to about 80% w/w, hereinafter w/w is an abbreviation for total weight basis (i.e. the mass of the water is 20 to 80% of the total mass of the mixture), of the starchy material and water. A heating device can be provided around the high shear processor for providing a superambient temperature in a range from about 80° C. to about 150° C. The high shear processor can have one or more rotating shafts with one or more paddles for applying force and preferably has two shafts with paddles.

Another further step comprises reducing the moisture of the processed product to produce a reduced moisture product, which can preferably occur in the high shear processor. The reduced moisture product can be powder, flakes, chunks, or mixtures thereof and can have a moisture content of about 70% w/w or less or 10% w/w or less depending on the type of starchy material. The reduced moisture product having 10% w/w or less moisture can be contacted with ethanol and water to dehydrate the ethanol.

The reduced moisture product and water at a subambient, ambient, or superambient temperature can form a highly viscous paste that has a viscosity greater than that of distilled water.

A further step can comprise introducing a liquefaction enzyme, such as alpha-amylase, into the high shear processor to liquefy the processed product.

A further step comprises contacting a liquid extractant and the reduced moisture product to form a first mixture that can comprise an alcohol extractable product comprising oil and an alcohol soluble protein, and a residue product comprising fiber, gluten, and starch.

The alcohol extractable product can be separated from the residue product using the liquid extractant. The liquid extractant can be in the temperature range of about 50° C. to about 78° C. and can comprise ethanol, preferably about 85% to about 100% w/w; isopropanol; water; or mixtures thereof.

A further step for the processing of oil and an alcohol soluble protein such as zein, the liquid extractant can be removed from the alcohol extractable product and some of the oil can be separated from the alcohol extractable product to leave a further product. The further product is soluble in about 85% to about 100% w/w ethanol and comprises an alcohol soluble protein and oil. The alcohol soluble protein is thermoplastic and can comprise zein, kafirin, or a mixture thereof depending on the type of starchy material used. The oil comprises one or more carotenoids that can comprise lutein, zeaxanthin, lycopene, or mixtures thereof. The oil preferably contains a minimum of 250 ppm of carotenoids.

A further step for processing of the reside product can comprise reducing the amount of the liquid extractant in the residue product to a preferable range of about 0.4 to about 2.0 kg per ton of residue product.

The residue product and water can be mixed to form a second mixture, where the residue product to water ratio is in the range of about 1 to about 2.0 to about 1 to about 4.0. The second mixture can be heated to a superambient temperature in the range of about 85° C. to the boiling temperature of the second mixture.

Further steps for the production of sugar syrup comprises separating the fiber and the gluten from the second mixture leaving a sugar syrup to be processed and removing impurities from the sugar syrup. The fiber, gluten, and mixtures thereof can also be dried.

Further steps for the production of ethanol can comprise adding a saccharification enzyme to saccharify the starch into a sugar syrup and adjusting the pH and temperature of the second mixture for the saccharification enzyme. The saccharificatoin enzyme can comprise glucoamylase, pullulanase, or mixtures thereof. One embodiment can provide separating the fiber and gluten from the sugar syrup and drying the fiber and gluten.

In another embodiment, the second mixture can undergo further steps comprising adjusting the pH of the second mixture above 6.8, heating the second mixture to about 80° C. to about boiling temperature of the second mixture, separating the fiber and gluten from the second mixture leaving a sugar syrup to be processed, and drying the fiber, the gluten, or mixture thereof.

Still more steps can comprise fermenting the sugar syrup in the presence of a micro-organism that can ferment the sugar to produce a fermented product, and distilling the fermented product to produce a distilled product that comprises ethanol and water. The distilling step can also produce a distilling residue that can be recycled back into the second mixture. The fermented product can comprise beer and carbon dioxide and the distilled product can comprise at least 95% w/w ethanol and about 5% water. Further steps can comprise removing the water from the distilled product to produce anhydrous ethanol and adding denaturant to the anhydrous ethanol.

A further embodiment of the invention provides a method of processing a starchy material to produce ethanol comprising the steps of introducing water, a starchy material, and a liquefaction enzyme into a high shear processor; applying such a force to the material that is at a superambient temperature within the processor to mill, mix, gelatinize some of the starch of the starchy material, and liquefy, thereby producing a processed product; reducing the moisture of the processed product to produce a reduced moisture product; contacting a liquid extractant and the reduced moisture product to form a first mixture comprising an alcohol extractable product comprising oil and an alcohol soluble protein, and a residue product comprising fiber, gluten, and starch; separating the alcohol extractable product from the residue product using the liquid extractant; reducing the amount of the liquid extractant in the residue product; forming a second mixture comprising the residue product and water and heating the second mixture to a superambient temperature; saccharifying some of the starch in the second mixture at a superambient temperature; separating the fiber and the gluten from the second mixture leaving a sugar syrup to be processed; fermenting the sugar syrup in the presence of a micro-organism that can ferment the sugar to produce a fermented product that comprises beer and carbon dioxide, and distilling the fermented product to produce a distilled product that comprises ethanol and water; removing the water from the distilled product to produce anhydrous ethanol; and adding a denaturant to the anhydrous ethanol.

Another embodiment of the invention comprises a starchy material processing system comprising a high shear processor that can receive a starchy material and water for milling, mixing, and gelatinization of some of the starch of the starchy material; a first extractor having an extractant that can separate an alcohol extractable product comprising a protein and oil and a residue product comprising gluten, and starch; a de-solventizer device to reduce residual extractant in the extracted residue; a slurry tank to mix water, a second enzyme, and extracted residue at a superambient temperature to form a second mixture comprising fiber, gluten, and sugar syrup; and a separator device for separating fiber and gluten from the sugar syrup.

The system can further comprise a drier to dry the fiber, gluten or a mixture thereof.

The system can still further comprise an evaporator device to remove the extractant from the alcohol extractable product and a second separator device to separate the protein and oil in the alcohol extractable product.

The system can further comprise a fermentation device for fermenting the sugar syrup with a micro-organism that can ferment the sugar to produce a fermented product; a distillation device for distilling the fermented product comprising ethanol and water; a second separator device for separating the water from the ethanol to produce anhydrous ethanol; and a mixing device for adding denaturant to the anhydrous ethanol.

In still another embodiment provides a method of processing a starchy material comprising the steps of introducing a starchy material, liquefaction enzyme, and water into a high shear processor; applying shear force to the material that is at a superambient temperature within the processor to mill, mix, gelatinize some of the starch of the starchy material, and liquefy, thereby producing a processed product; reducing the moisture of the processed product to produce a reduced moisture product; and forming a second mixture comprising the reduced moisture product and water.

A further step can comprise separating the fiber, the gluten, and the oil from the third mixture leaving a sugar syrup to be processed. The oil can be separated from the gluten and fiber and/or the oil, fiber, and gluten can each be separated from on another. The fiber, gluten, and mixtures thereof can then be dried.

Another embodiment can comprise saccharifying some of the starch in the second mixture at a superambient temperature leaving a sugar syrup to be processed; fermenting the sugar syrup in the presence of a micro-organism that can ferment the sugar to produce a fermented product, and distilling the fermented product to produce a distilled product. The distilled product can comprise at least 95% ethanol and water. The water can be removed from the distilled product to produce anhydrous ethanol and a denaturant can be added thereto. The distilling step can also produce a distilling residue that can be recycled into the second mixture.

The invention can advantageously provide improvements over the conventional wet and dry milling methods by eliminating several of the steps and processing equipment necessary at those steps. The invention can also advantageously require less capital investment and less operating cost due to the elimination of these wet and dry milling steps. Furthermore, the emissions of the invention can be less than that of the wet and dry milling methods.

The invention can also advantageously produce ethanol, sugar syrup, and starch as the chief products along with food-grade co-products such as, but not limited to oil, protein, fiber, and gluten meal.

### DESCRIPTION OF DRAWINGS

FIG. 1 is a schematic illustration of a starchy material processing method in accordance with an illustrative embodiment of the invention to produce corn oil, zein, fiber, gluten meal, and ethanol. Particulate matter is referred to as PM and volatile organic compounds are referred to as VOC in several of the figures.

The schematic in FIG. 2 illustrates a process similar to FIG. 1 but producing corn syrup in the main processing stream instead of ethanol.

FIG. 3 is a schematic illustration of a processing method in accordance with an illustrative embodiment of the invention using corn to produce corn oil, gluten meal, fiber, and ethanol.

FIG. 4 is a schematic illustration of a processing method in accordance with an illustrative embodiment of the invention using corn to produce fiber, oil, gluten meal, and corn syrup.

FIG. 5A is a perspective of a single flat paddle that can be mounted on the shaft of a high shear processor in accordance with an illustrative embodiment of the invention.

FIG. 5B is a side view of the flat paddle shown in FIG. 5A.

FIG. 6A is a front view of the paddle of FIG. 5A, shown at zero degrees rotation (referred to as the number 1 position).

FIG. 6B is a front view of the paddle of FIG. 5A, shown at 45 degrees counter-clockwise rotation (referred to as the number 2 position).

FIG. 6C is a front view of the paddle of FIG. 5A, shown at 90 degrees rotation (referred to as the number 3 position).

FIG. 6D is a front view of the paddle of FIG. 5A, shown at 45 degrees clockwise rotation (referred to as the number 4 position).

FIG. 7 is a perspective view of feeder screws and flat paddles on twin shafts for use in a high shear processor pursuant to the invention.

FIG. 8 is a schematic illustration of the conventional wet milling process to produce ethanol, corn oil, fiber gluten meal, and distiller grain from corn.

FIG. 9 is a schematic illustration of the conventional dry milling process to produce ethanol, and distiller grain from corn.

### DETAILED DESCRIPTION OF THE INVENTION

The invention is especially useful in corn processing but is not limited thereto as other kinds of starchy materials such as sorghum, millet, rice, oat, wheat, barley, buckwheat, rye, sweet potato, potato, cassaya, pure starch, soybean, and mixtures thereof can be processed by the present invention. The starchy material may be a whole grain or a partially processed or processed starchy material substrate.

The invention is described below in respect to processing of corn kernels for purposes of illustration only and not limitation.

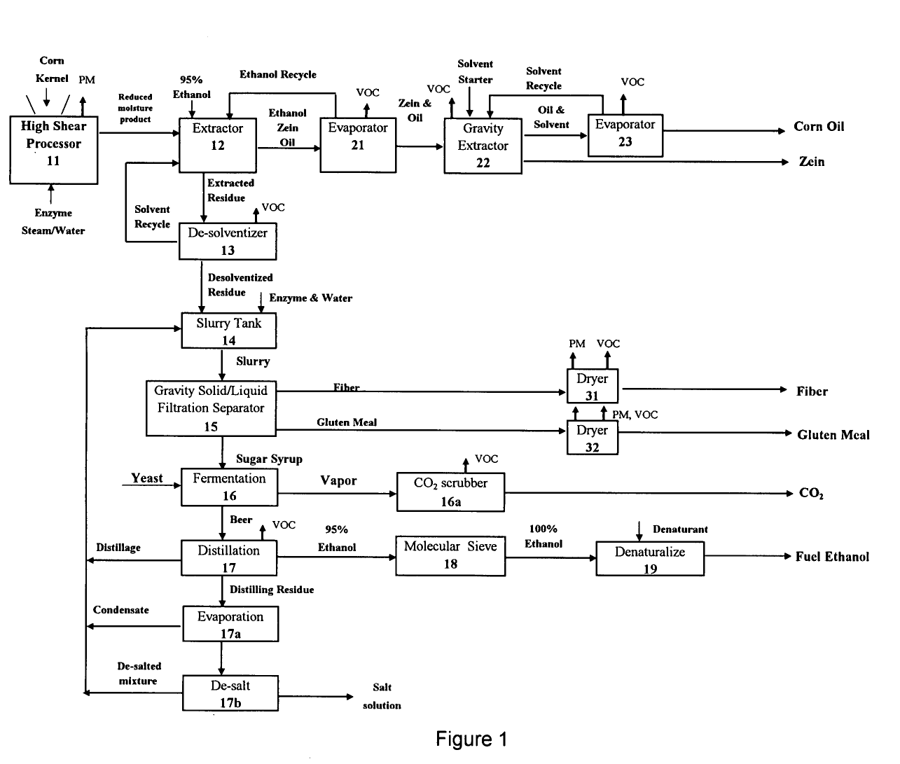

An illustrative embodiment of the invention is shown in the schematic illustration in FIGS. 1 and 2. In this embodiment, the starchy material comprising corn kernels can be cleaned to remove stones and rocks prior to processing. The corn kernels and water are introduced into a high shear processor 11, 41. The water can be in the form of liquid water or vapor, which can be at a superambient temperature. For example, the corn kernels and steam can be separately introduced into the barrel of the high shear processor. The water is introduced into the barrel in an amount sufficient to achieve moisture content in the range of about 20% to about 80% w/w of the starchy material and water and preferably achieves a moisture content of about 25% to about 50% w/w. The amount of water added to the starchy material is dependent on the nature of the starchy material. The invention also envisions that other liquids such as ethanol, glycerol, or other plasticizers can be introduced into the barrel to obtain various functional properties in the processed product.

The water can be in liquid or vapor form when introduced into the barrel of the high shear processor. The water can be at a superambient temperature such as using steam to heat the corn and water mixture to a superambient temperature.

Alternately, a heating device can be provided around the high shear processor to heat the corn and water mixture to a superambient temperature in the barrel of the processor during the application of shear force to the mixture. The heating device can be a conventional steam jacket. For example and not limitation, a five inch processor with an integral steam jacket can provide pressure of about 60 to about 150 psi to heat the starchy material and water in the barrel of the processor; however, the invention envisions that other size processors with steam jackets can use other ranges of pressure to heat the materials in the barrel. The heating device can also be a conventional electrical heating element or other device suitable for heating the material in the barrel of a processor. If electric heating is used, the temperature in the jacket can be as high as 280° C.

The superambient temperature of the starchy material and water in the barrel of the processor can be in a range from about 80° C. to about 150° C. and is preferably in the range of about 120° C. to about 140° C.

The high shear processor 11, 41 is of a design that is capable of applying shear force to the corn within the processor to mill, mix, and gelatinize some of the starch in the corn and water mixture to produce a processed product. For purposes of illustration, a suitable high shear processor can comprises a twin screw continuous processor jacketed with high pressure steam and is commercially available from Readco Manufacturing Company, York, Pa. However, the invention is not limited to such equipment and can be practiced using other kinds of continuous or batch high shear processors such as a single or twin screw extruder, kneader, or other equipment capable of producing high shear for processing pursuant to the invention.

The high shear processor can have one or more rotating shafts with one or more paddles positioned thereon for applying shear force and, preferably, has two shafts with paddles. Each shaft is placed within a barrel that conforms closely to the shape of the paddle assembly.

In a preferred embodiment application of force or high shear is accomplished using a sequence of paddles on twin shafts of a high shear processor. The paddles rotate during operation and can be of the flat or helical type. The flat paddles apply high shear rates, intense mixing action, and can convey material down the barrel toward the discharge end. The helical paddles can be the conventional forward or reverse type helical paddles and can be used to convey the material to the discharge end.

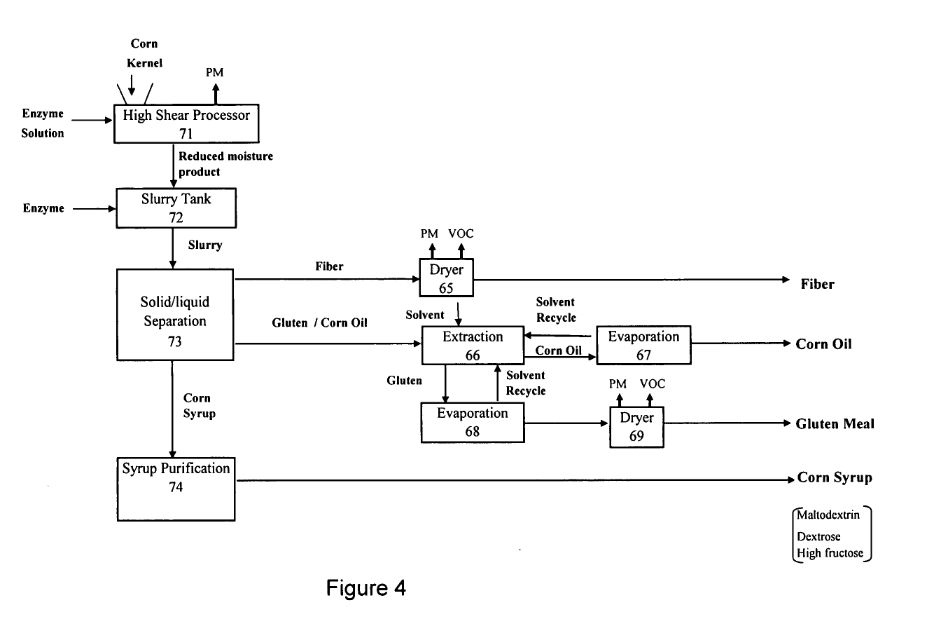

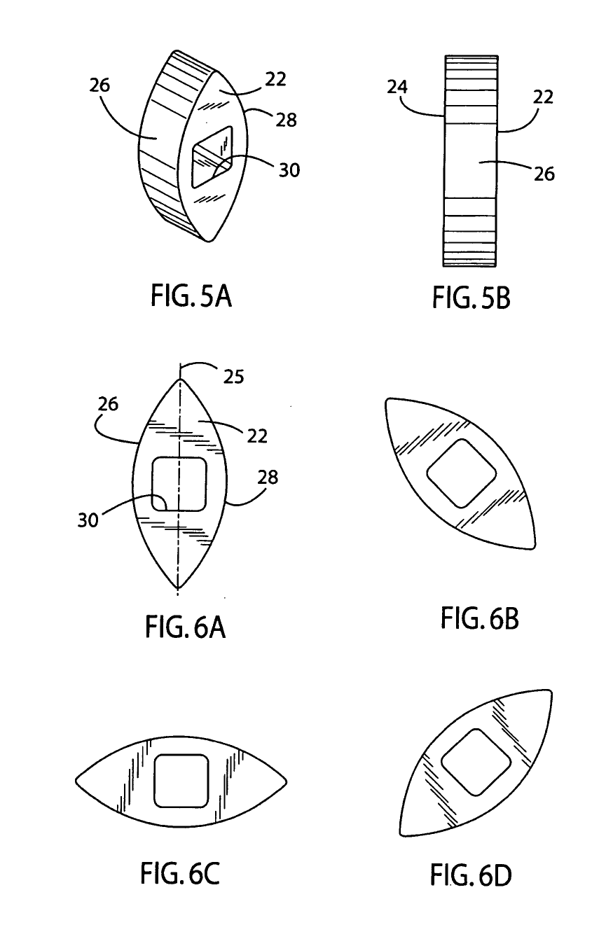

A flat paddle is shown in FIGS. 5A, 5B, and 6A-6D and has a first flat surface 22 and a second flat surface 24 that are parallel to each other. A first curved surface 26 and a second curved surface 28 are concave surfaces that oppose each other. Each of the flat surfaces 22, 24 intersect only the curved surfaces 26, 28. An opening 30 is perpendicular to the flat surfaces 22, 24 and provided through the center of the flat paddle for mounting on the shaft 40.

Referring to FIGS. 6A to 6D, the flat paddles can be positioned on the shaft 40 at various rotational angles relative to one another. The No. 1 position is shown in FIG. 6A and is at zero degrees relative to vertical line 25. The No. 2 position is shown in FIG. 6B and is 45 degrees counter-clockwise from the vertical line 25. The No. 3 position is shown in FIG. 6C and is at 90 degrees from the vertical line 25. The No. 4 position is shown in FIG. 6D and is at 45 degrees clockwise rotation from the vertical line 25.

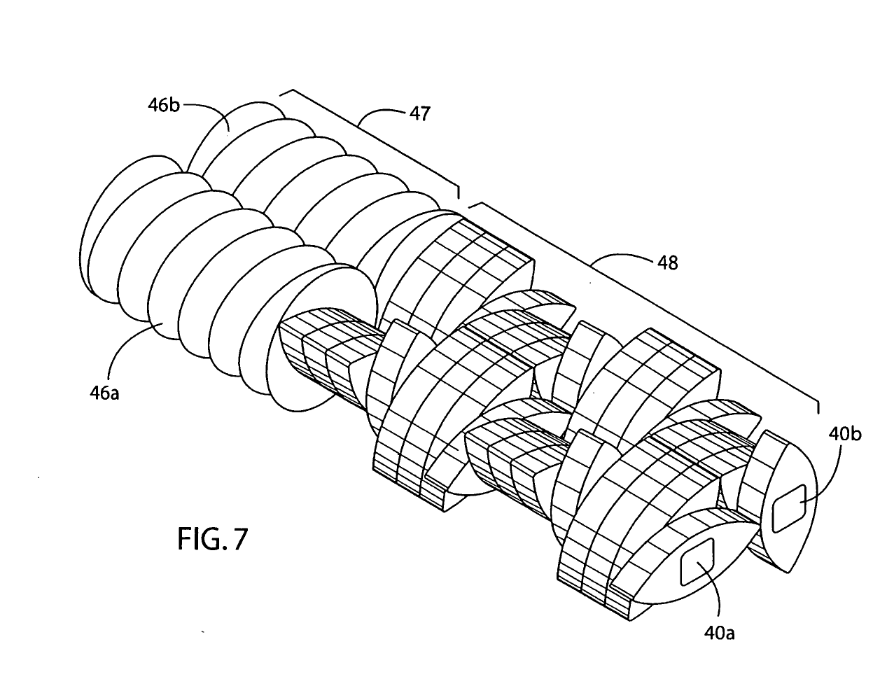

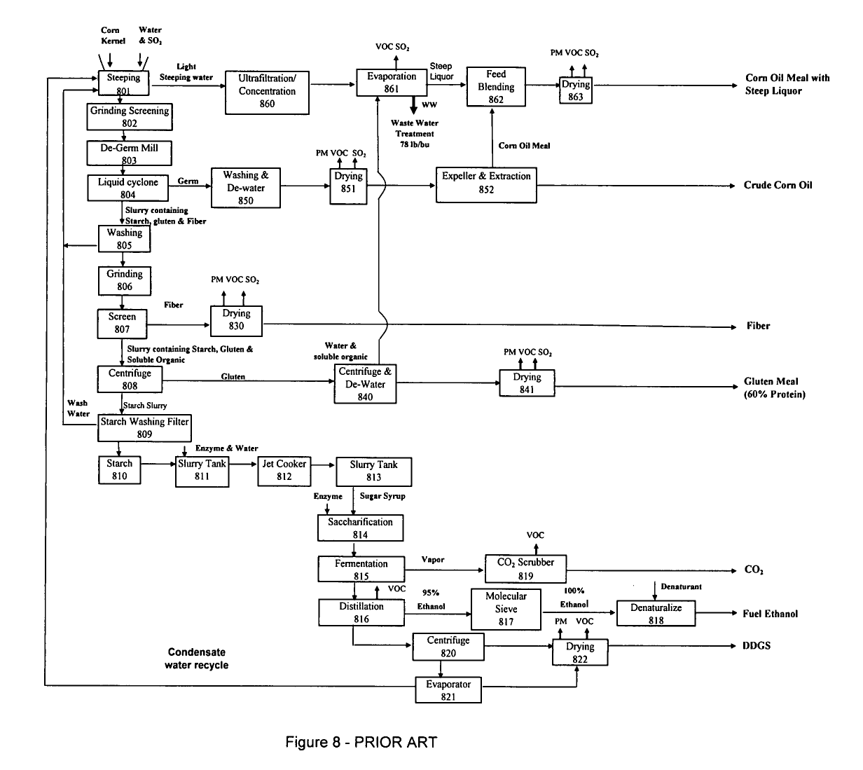

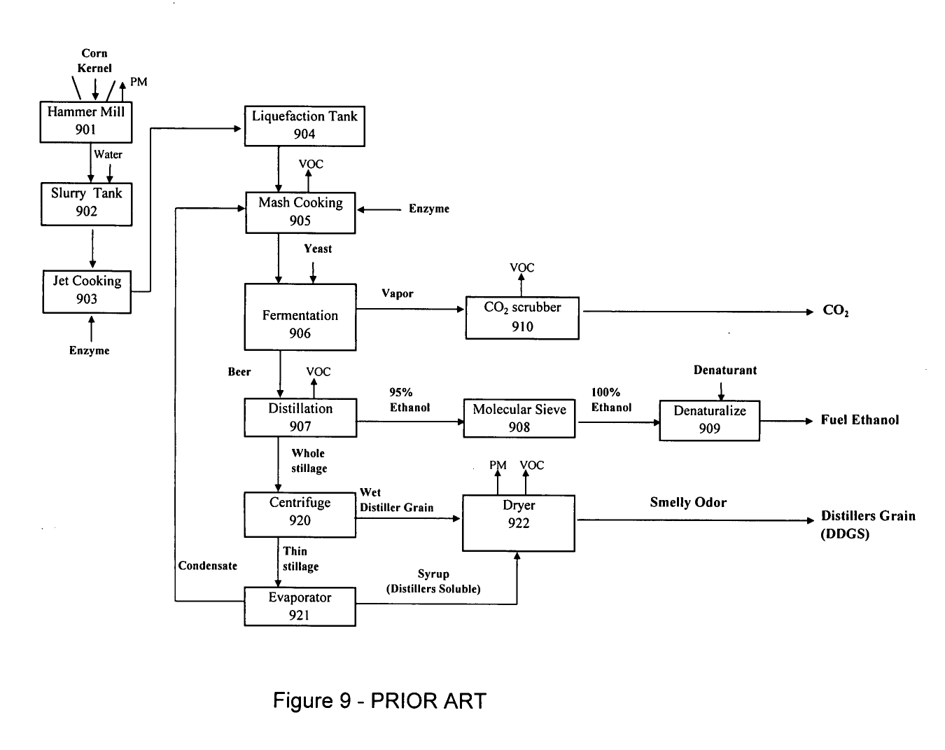

An illustrative embodiment of twin shafts 40a, 40b each having a feeder screw section 47 and paddle section 48 that can be provided in the barrel of a high shear processor is shown in FIG. 7. The feeder screws 46a, 46b feed the corn kernels into the barrel of the processor. The feeder screws 46a, 46b can be controlled by conventional methods known in the art, such as a microcontroller. The corn kernel and water mixture moves through the barrel by the configuration of the paddles and is subjected to shearing forces applied by the paddles therein.

The paddle configuration in FIG. 7 is an illustrative embodiment not meant for limitation for a five inch twin-screw high shear processor having a high pressure stearn jacket available from Readco Manufacturing Company, York, Pa. The specific paddle configuration shown in FIG. 7 is indicated in Table 1 below, where position 1 is the paddle adjacent to the feeder screw 46a, 46b:

TABLE 1

| Longitudinal | | Longitudinal | |
|---|---|---|---|
| Position | Rotational | Position | Rotational |
| Shaft 40A | position | Shaft 40B | Position |
| 1 | 2 | 1 | 4 |
| 2 | 2 | 2 | 4 |
| 3 | 2 | 3 | 4 |
| 4 | 1 | 4 | 3 |
| 5 | 4 | 5 | 2 |
| 6 | 4 | 6 | 2 |
| 7 | 4 | 7 | 2 |
| 8 | 3 | 8 | 1 |
| 9 | 2 | 9 | 4 |
| 10 | 2 | 10 | 4 |
| 11 | 2 | 11 | 4 |
| 12 | 1 | 12 | 3 |
| 13 | 4 | 13 | 2 |
| 14 | 4 | 14 | 2 |
| 15 | 4 | 15 | 2 |
| 16 | 3 | 16 | 1 |

During operation of a five inch processor, the shafts 40a and 40b of the five inch processor can rotate in a range of about 50 to about 250 revolutions per minute (RPM). The feed rate can be in a range of about 1,000 to about 2,000 g per minute. The pressure in the steam jacket of the five inch processor can be between about 60 to about 150 psi to heat the starchy material and water in the barrel of the processor to about 80° C. to about 150° C. The invention is not limited to these operational parameters as other processor settings maybe used to achieve a processed product pursuant to the invention.

The invention envisions that the paddle configuration can use flat and helical paddles and different longitudinal and rotational positions of the paddles depending on the type of material to be processed, the type of processor, and desired processing time. For example, a high shear processor larger than the five inch processor described above could have the following paddle configuration as shown in Table 2 below using both flat (F) and forward helical (H) paddles:

TABLE 2

| Longitudinal | | | Longitudinal | | |
|---|---|---|---|---|---|
| Position | Paddle | Rotational | Position | Paddle | Rotational |
| Shaft A | type | Position | Shaft B | Type | position |
| 1 | H | 4 | 1 | H | 2 |
| 2 | H | 3 | 2 | H | 1 |
| 3 | F | 2 | 3 | F | 4 |
| 4 | F | 2 | 4 | F | 4 |
| 5 | H | 1 | 5 | H | 3 |
| 6 | H | 4 | 6 | H | 2 |
| 7 | F | 3 | 7 | F | 1 |
| 8 | F | 3 | 8 | F | 1 |
| 9 | H | 2 | 9 | H | 4 |
| 10 | H | 1 | 10 | H | 3 |
| 11 | F | 4 | 11 | F | 2 |
| 12 | F | 4 | 12 | F | 2 |
| 13 | H | 3 | 13 | H | 1 |
| 14 | H | 2 | 14 | H | 4 |
| 15 | F | 1 | 15 | F | 3 |
| 16 | F | 1 | 16 | F | 3 |
| 17 | H | 4 | 17 | H | 2 |
| 18 | H | 3 | 18 | H | 1 |
| 19 | F | 2 | 19 | F | 4 |
| 20 | F | 2 | 20 | F | 4 |
| 21 | H | 1 | 21 | H | 3 |
| 22 | H | 4 | 22 | H | 2 |
| 23 | F | 3 | 23 | F | 1 |
| 24 | F | 3 | 24 | F | 1 |
| 25 | H | 2 | 25 | H | 4 |
| 26 | H | 1 | 26 | H | 3 |
| 27 | F | 4 | 27 | F | 2 |

A reverse paddle may be used as the twenty-eighth paddle on each shaft to assist the processed product in falling through the discharge end. The operational settings for the high shear processor can be determined empirically to achieve the desired results in the processed product.

The paddle configuration in the high shear processor applies force to the corn and water mixture that are at a superambient temperature in the barrel of the processor to achieve milling, mixing, and gelatinization of some of the starch to produce a processed material. The invention accomplishes processing steps in one piece of equipment to provide thorough milling and mixing, while allowing starch gelatinization and hydrolysis in a semisolid state. Milling grinds the corn into minute grains by the crushing and grinding action of the paddles. The mixing action combines the ingredients in the barrel of the processor. Gelatinization occurs under superambient temperature when some of the hydrogen bonds in the insoluble starch granules are broken. The starch granules are then open to hydration and able to form water soluble starch granules. The high shear processing reduces the molecular weight of the starch, decreases the viscosity of the starchy material and water, and forms a protein and oil complex in the processed product.

Additionally, a liquefaction enzyme can be introduced into the barrel of the high shear processor to achieve liquefaction of the starchy material and water. The liquefaction enzyme is preferably alpha-amylase (trade name Spezyme Fred), which is commercially available from Genencor of Palo Alto, Calif.; however, other commercially available liquefaction enzymes and their respective dosage can be used to achieve liquefaction of the starchy material and water in the barrel of the processor. The liquefaction enzyme converts the suspended water soluble starch granules into shorter chain and less viscous dextrins in the processed product and can reduce energy consumption during processing. The high shear action in the processor improves the efficiency of enzyme hydrolysis by continuously exposing the starch molecules to the liquefaction enzyme. The invention provides that the starchy material is in a semi-solid state in the processor. Alpha-amylase is more stable in a semi-solid material than in liquid and it can retain part of the original activity after exiting the processor. The processing temperature of the starchy material and water can be up to 150° C. to complete gelatinization of the starch, which is also beneficial for the alpha-amylase enzyme hydrolysis. During the high shear processing, the protein and oil form a complex that prevents the oil from forming a barrier between the starch and the enzyme, which increases the efficiency of the enzyme to hydrolyze starch to completion. Hydrolysis of starch by the alpha-amylase can continue into the slurry tank 14, 44 since some of the residual alpha-amylase can remain in the processed product.

The moisture can then be reduced in the processed product and preferably occurs in the high shear processor but may also be accomplished by other conventional methods such as drying in an oven to achieve the desired moisture content. The heating device of the high shear processor can provide a superambient temperature sufficient to reduce the moisture content in the processed product in the barrel of the processor. The processed product can leave the discharge end of the processor as a reduced moisture product. The reduced moisture product may be in the form of powder, flakes, chunks, or mixtures thereof.

The reduced moisture product can form a highly viscous paste when mixed with water. The invention is especially useful for forming a highly viscous paste using water at a sub-ambient or ambient temperature; however, water at a superambient temperature can also be used. The amount of water added to the reduced moisture depends on the type of starchy material used and the desired outcome. The ratio of reduced moisture product to water can preferably range from about 1:0.5 to 1:15. The highly viscous paste can have a viscosity greater than that of distilled water, which has a viscosity of 1 centipoise (cps) at ambient temperature. For illustration and not limitation, 10 grams of reduced moisture product samples of various starchy materials having a particle size of less than 60 mesh were each mixed with water at the ratios shown Table 3. The reduced moisture product and water were blended for 1 minute using a conventional Bruan handheld blender to form the highly viscous paste. The viscosity of paste was determined using a commercially available DX II Brookfield viscometer at 12 rpm using a 31 spindle and provided the following viscosities for the samples:

TABLE 3

| | Viscosity (cps) | | | | | | | | | |
|---|---|---|---|---|---|---|---|---|---|---|
| | | | | | | | | | Whole | Sweet |
| | | | | | | | | | corn | rice |
| | | | Potato starch | | Corn meal | | Sorghum | | powder | powder |
| | Corn starch to | | powder to | | powder to | | powder to | | to | to |
| | water | | water | | water | | water | | water | water |
| Time | 1:7 | 1:15 | 1:7 | 1:15 | 1:5 | 1:7 | 1:7 | 1:10 | 1:5 | 1:7 |
| (min) | ratio | ratio | ratio | ratio | ratio | ratio | ratio | ratio | ratio | ratio |
| 0 | 1900 | 100 | 2700 | 120 | 5055 | 431 | >10,000 | 300 | 6050 | 1140 |
| 5 | 4800 | 100 | >10,000 | 220 | 6800 | 460 | | 401 | 6500 | 1200 |
| 10 | >10,000 | 100 | | 534 | 6599 | 501 | | 531 | 7200 | 1260 |
| 15 | | 115 | | 616 | 6791 | 676 | | 501 | 7300 | 1280 |
| 20 | | 115 | | 616 | 6800 | 797 | | 506 | 7300 | 1320 |

The invention is not limited to the illustrative examples above as other reduced moisture product to water ratios and water temperatures can be used to provide a highly viscous paste pursuant to the invention.

The reduced moisture product can have a moisture content sufficiently low for further processing, which can be less than about 70% w/w or less, and preferably less than about 10% w/w or less, and more preferably between about 10% to 3% w/w. The moisture content can be determined by the desired product. For example, if the reduced moisture product is to be further processed for oil and zein production then the moisture content is preferably less than about 20% w/w or less when using 95% ethanol for extraction. For maximum efficiency in the extraction of the oil and zein, the reduced moisture product can be less than about 10% w/w or less and contacted with the 95% ethanol to contemporaneously dehydrate the 95% ethanol to about 98-100% ethanol at the extraction step 12, 42.

The reduced moisture product can then be contacted with the liquid extractant to form a first mixture comprising an alcohol extractable product and residue product. The alcohol extractable product can comprise oil and an alcohol soluble protein such as, but not limited to, zein derived from corn, kafirin derived from sorghum, or mixtures thereof.

The alcohol extractable product can be separated from the residue product using a liquid extractant in a first extractor 12, 42 or other conventional extracting device such as but not limited to a gravity solvent extractor: Ethanol, isopropanol, water, or mixtures thereof can be used as the liquid extractant; however, the invention envisions that other liquid extractants capable of separating the residue produce and the alcohol extractable product can be used. Preferably, the liquid extractant is ethanol in concentration the range of 85 to 100% w/w ethanol balance water with the more preferred concentration in the range of 95 to 98% w/w ethanol basis water. The temperature of the liquid extractant can be in a temperature range of about 50° C. to about 78° C. and is preferably in the range of 65° C. to 75° C. Under the high shear conditions in the processor, the alcohol soluble protein that can comprise corn zein and corn oil form a complex that is soluble in 85 to 100% w/w ethanol basis water at a temperature above 50° C. This characteristic of the complex makes it possible to quantitatively and simultaneously extract corn oil and protein. Extraction can be achieved by conventional means one of which is described in example 1.

The liquid extractant can then removed by conventional means such as cooling or evaporation in an evaporator device 21, 24. The evaporation may be achieved using a rotary evaporator or other conventional equipment. Membrane technology, or other equipment commonly used in the art may also be used to remove the extractant. Furthermore, the evaporated extractant can be recycled back to the extractor 12, 42 for further extractions.

When the extractant is removed, the alcohol extractable protein of the alcohol extractable product becomes solid. This allows the alcohol soluble protein to be separated from some of the oil. Decanting, straining, filtration, use of a centrifuge, gravity extractor 22, 25, or other conventional device can be used to separate the alcohol soluble protein from some of the oil leaving a further product. The extractor 22, 25 preferably uses a solvent that is preferably hexane to separate the protein from some of the oil since the oil is soluble in hexane and alcohol soluble protein is not. The extracted oil and solvent can be transferred to the evaporator 23, 26 where the solvent can be recovered for recycling back into the extractor 22, 25 and leaves oil as a co-product of the process.

After removal of some of the residual oil, the further product now comprises an alcohol extractable protein and some oil, which can be described as a protein-oil complex. The increased solubility in alcohol allows the material to be extracted simultaneously with oil and is different from unprocessed zein protein that is only soluble in 60-80% ethanol. The protein-oil complex has thermoplastic properties and is soluble in about 85% to about 100% w/w ethanol. Thermoplastic is defined as a material capable of becoming soft when heated and rigid when cooled for a limited time. The protein-oil complex is food grade, which means fit for consumption by a human, and bio-degradable, which means capable of being decomposed by biological agents.

The separated oil can comprise one or more carotenoids. Carotenoids can come in many different forms and their content varies widely depending on the type of starchy material. Starchy materials like corn and sorghum can produce an oil that can comprise one or more carotenoids such as, but not limited to lutein, zeaxanthin, lycopene, or mixtures thereof. The oil can contain a minimum of 250 ppm of carotenoids. For example and not limitation, the carotenoid content of materials processed pursuant to an embodiment of the invention shown in FIG. 1 is listed below in Table. 4.

TABLE 4

CRUDE OIL CARTENOID CONTENT (PPM)

| | Lutein | Zeaxanthin | β-carotene | Total |
|---|---|---|---|---|
| Corn | 1558 | 1268 | 243 | 3352 |
| Sorghum | 777 | 932 | 111 | 1820 |
| Soybean | 75 | N/D | N/D | 75 |

Carotenoids were analyzed as described by HPLC as described by Puspitasari-nienaber et al. (2002)

The carotenoid content was determined by HPLC using the method described by Puspitasari-nienaber, N. L. Ferruzzi, M. G., and Schwartz, S. J. entitled “Simultaneous detection of tocopherols, carotenoids and chlorophylls in vegetable oils by direct injection C30 RP-HPLC with coulometric electrochemical array detection” published in volume 79 of the Journal of the American Oil Chemistry Society (2002) on pages 633-640. The invention envisions that the carotenoids can be separated from the oil using conventional methods.

The protein-oil complex and oil with carotenoids co-products of the invention can provide improved values over traditional co-products such as distillers grains, thereby reducing processing costs.

The residue product can be further transferred from the extractor 12, 42 to a de-solventizing device 13, 43. The de-solventizing device 13, 43 can apply heat and vacuum to the residue product for removing some of the residual liquid extractant. The amount of liquid extractant in the residue is dependent on whether the residue product will be processed for ethanol or sugar syrup and can range from about 0.4 to about 2.0 kg per ton of residue product. If the residue product will be used for ethanol product, the residual solvent can contain more than about 2 kg of liquid extractant per ton of residue product. However, if the residue product is used for sugar syrup production the residual ethanol should be about less than 0.8 kg per ton. The recovered liquid extractant can be condensed and recovered for recycling and further use in the extractor 12, 42.

A second mixture can then be formed with the residue product and water in the slurry tank 14, 44. The second mixture can have a residue to water ratio in the range of about 1 to 2.0 to about 1 to about 4.0 and preferably has a residue to water ratio of about 1 to about 2.3. The second mixture can be a low viscosity slurry that contains approximately 35% w/v of sugar. The slurry can then be heated to a superambient temperature in the range of about 85° to about the boiling temperature of the second mixture. Heating the slurry can accelerate the starch dispersion process and residual alpha-amylase can continue to hydrolyze starch in the second mixture to a desired DE value. The slurry can undergo further processing dependent on whether the chief product is sugar syrup or ethanol.

For sugar syrup production, the heating of the second mixture slurry can be extended to produce a desired DE value. For example and not limitation, the DE of the syrup can range from about 5 to 42 for the production of glucose. The sugar syrup can be separated from the second mixture leaving fiber and gluten as shown in the illustrative embodiment in FIG. 2. The sugar syrup can be purified using conventional purification 46 methods and dried to maltodextrin having various DE values such as, but not limited to DE 10, DE 24, or DE 42 maltodextrin. Further conventional processing steps such as, but not limited to adding water, heating, adjusting the pH, and addition of enzymes to the maltodextrin can be used to produce sugar syrup products like glucose, maltose, dextrose, maltodextrin, and high fructose corn syrup. For example, water can be added to the maltodextrin having a DE between 5 and 42, the pH of the water and maltodextrin mixture can be adjusted to about 4.5 to about 5, and gluco-amylase can be added to convert maltodextrin to glucose. For another example, water can be added to the maltodextrin, the pH of the water and maltodextrin mixture can be adjusted to about 4.5, the temperature of the water and maltodextrin mixture can heated to 60° C., and maltase can be added to convert the maltodextrin into maltose.

The second mixture can alternatively undergo saccharification for ethanol production in the slurry tank 14. To achieve saccharification of the starch into a sugar syrup a saccharification enzyme such as, but not limited to gluco-amylase, pullulanase, or mixtures thereof can be added to the second mixture. Addition of pullulanase is optional because it depends on the type of yeast strain used in the fermentation process. The pH and temperature range of the second mixture can be adjusted for the specific enzyme. The saccharification enzyme can be added to the second mixture at a pH of about 3.5 to about 5.0 and a temperature of about 50° C. to about 65° C. For illustration and not limitation, gluco-amylase commercially available from Novozymes of Bagsvaerd, Denmark in an amount of 0.5 to 5.0 ml per kilogram of starch in the second mixture can be used as a saccharification enzyme when the second mixture has a pH of about 3.5 to about 5 and at a temperature of about 55° C. to about 65° C. The invention also envisions using conventional acid hydrolysis methods for saccharification.

The second mixture can be further processed to facilitate separation of the fiber and gluten from the sugar syrup. The pH of the second mixture can be adjusted to above 6.8 to denature any remaining proteins and the temperature can be at about 80° C. to about the boiling temperature of the second mixture. If the sugar syrup is used for ethanol production, ammonia is preferred for adjustment of the pH. These optional steps can improve the efficiency of sugar syrup separation from the fiber and gluten meal.

For either the sugar syrup or ethanol production, the fiber and gluten meal can be separated from the sugar syrup in the separator device 15, 45 and dried using the fiber drier 31, 34 and the gluten meal drier 32, 35, respectively. The low viscosity of the second mixture allows the use of filtration to remove the relatively larger fiber particles. The filtration can be achieved using a screen of a solid/liquid gravity filtration separation device or other conventional methods sufficient to separate the fiber particles from the second mixture. The fiber and gluten meal can be in the form of filter cake. The fiber and gluten meal can then go through a filtration media of a solid/liquid gravity filtration separation device, where the finer gluten meal particles can be removed from the gluten meal. The gluten meal can remain on the screen portion of the filter media and contains approximately 75% moisture.

The fiber can go through a dewatering press to remove residual water before being transferred to the dryer 31, 34. The fiber dryer 31, 34 and gluten meal dryer 32, 35 can be conventional dryers sufficient to achieve the desired moisture content in the fiber and gluten meal.

The sugar syrup can be placed in a fermentation device 16 in the presence of a micro-organism that can ferment the sugar to produce a fermented product such as, but not limited to yeast. For example and not limitation, the fermentation microorganism can be 10 ml of saccharomyces cerevisiae, commercially available from Red Star of Milwaukee, Wis., grown in YMP broth (yeast extract, malt extract, and bacto Peptone) for each liter of syrup that contains 20% w/w sugar. The amount of the fermentation microorganism is dependent on the microorganism used or the targeted fermented product. The fermentation can be done without the presence of corn solids and oil because the oil, zein, fiber, and gluten meal can be separated from the sugar syrup prior to fermentation. Without the grain solids, the fermentation does not have a “stuck” problem (a fermentation that fails to progress although sugar is still available), which is commonly found in the dry milling process. In addition, when the solids and oil are separated, the throughput of the fermentation tank can be at least 30% less than the conventional dry grind method. The reduced throughput at the fermentation step can reduce both capital cost and operation cost for this step. However, the invention also envisions that one or more of the oil, zein, fiber, and gluten meal can remain in the sugar syrup.

The fermentation process produces the fermentation product that can comprise beer and carbon dioxide. The beer can be an ethanol “beer”. The carbon dioxide can be about 33% of the output at the fermentation step 16. The carbon dioxide can be removed using a conventional CO₂ scrubber 16a or captured as an output. The captured carbon dioxide can be cleaned of any residual alcohol, compressed, and sold to other industries such as carbonated beverage producers, dry ice produces, food producers, and paper mills. The fermented product can be a final product processed for anti-biotic or other conventional use or can undergo distillation 17 to produce a distilled product.

The distilled product that can comprise ethanol and water and preferably is about 95% w/w ethanol and about 5% water. The distillation 17 can be done using a conventional distillation device and method such as using a distillation column to distill the ethanol. The distillation column is less likely to be entrained by solids as with the dry milling method since the invention can separate the grain oil and solids prior to the distillation step 17. The invention can also provide a reduced throughput capacity since distillation can occur without the grain oil and solids. The reduced throughput at the distillation step 17 can provide lower operating cost and capital investment when compared to the conventional dry milling method.

The distillation step can also produce a distilling residue at the bottom of the distillation column and can be recycled back into the slurry tank 14. This invention can eliminate the need to separate liquids at the distillation steps 816, 902 in wet and dry milling. Since corn and other starchy materials can have salts therein, the distilling residue can comprise salt and water soluble substances such as, but not limited to protein, solids, and yeast cell debris. The concentration of salt in the distilling residue can increase after several times of recycling the distilling residue into the slurry tank 14. When the salt concentration increases to a level that the yeast in the fermentation step 16 can not tolerate, the distilling residue can be de-salted for recycling. The de-salting procedure can be a conventional de-salting procedure sufficient to reduce the concentration of salt in the distilling residue such as but not limited to using an evaporator 17a to recover the water in the distilling residue, and using a conventional de-salting device 17b to crystallize the residual salts. The salt can then be filtered out, and the remaining liquid can be recycled back to the slurry tank 14 or the high shear processor.

The water can be removed using from the distilled product to produce anhydrous ethanol using a second separator device such as a molecular sieve 18. The ethanol can be rectified to anhydrous ethanol using conventional methods such as by passing the ethanol stream through a conventional molecular sieve 18. The ethanol at this stage can be called anhydrous ethanol because it is essentially pure, without water and is approximately 200 proof.

Denaturalization 19 can be the final step for ethanol production and makes the ethanol poisonous for human consumption. A small amount of gasoline such as but not limited to about 2 to about 5% w/w is added to the ethanol in a conventional mixing device to make it unfit for human consumption.

Ethanol made by the process described can yield about 2.85 gallons of ethanol per bushel of corn, which is more than both the wet milling method production of 2.45 gallons and the dry milling method of production of 2.80 gallons.

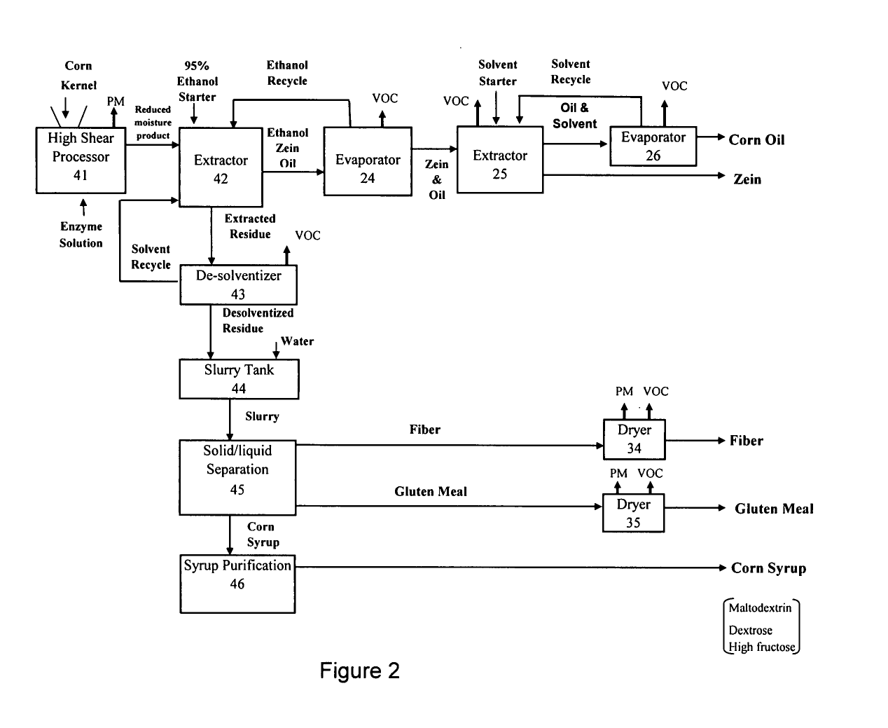

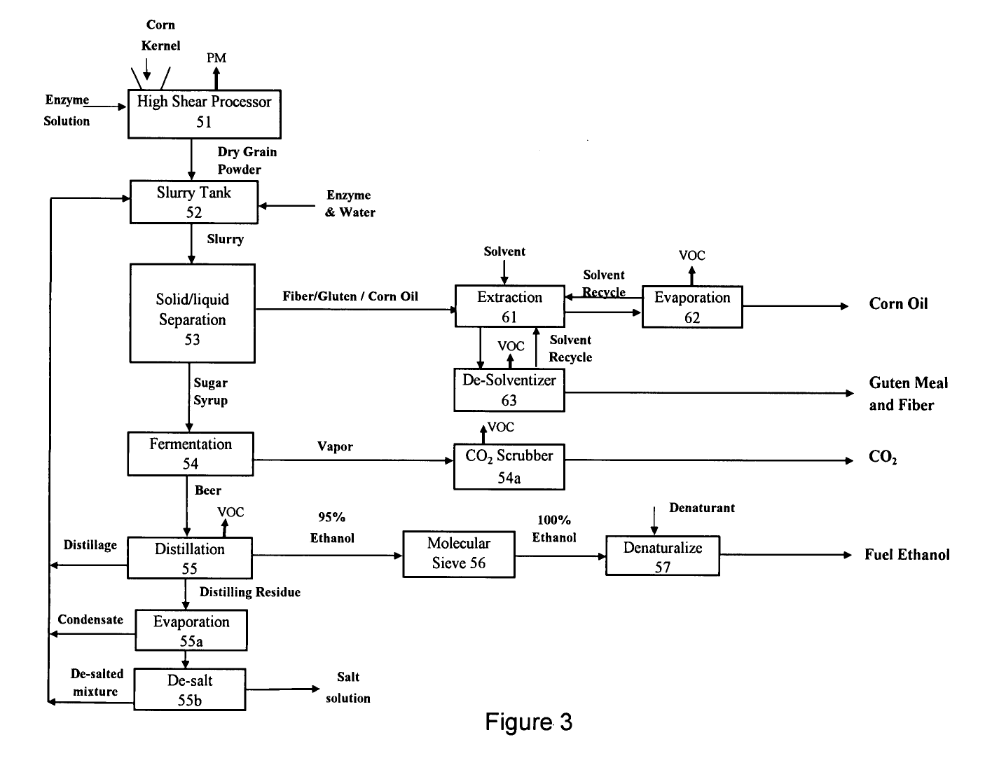

Additional embodiments of the invention are shown in FIGS. 3 and 4 for processing a starchy material without the steps of separating the oil-protein complex. The initial steps of these embodiments are the same as described above and comprise introducing a starchy material, liquefaction enzyme, and water into a high shear processor 51, 71; applying shear force to the material at a superambient temperature within the processor to mill, mix, gelatinize some of the starch of the starchy material, and liquefy, thereby producing a processed product; reducing the moisture of the processed product to produce a reduced moisture product comprising oil, protein, fiber, gluten, and starch; and forming a second mixture comprising the reduced moisture product and water in a slurry tank 52, 72.

The illustrative embodiment for ethanol processing shown in FIG. 3 can comprise adding a saccharification enzyme to the second mixture at a superambient temperature in the slurry tank 52 to convert the starch into fermentable sugars. Optionally, adjustment of the pH to above 6.8 and heating of the second mixture for 2 minutes above 80° C. can facilitate the separation of fiber and gluten from the second mixture. The second mixture can then proceed to a separating device 53 for separating the fiber, gluten, oil from the second mixture to leave a sugar syrup for ethanol processing.

The oil can then be separated from the gluten and fiber using a conventional extraction method such as using solvent in an extractor device 61. The solvent can then be removed from the oil in a conventional evaporation device 62 to provide the corn oil product. The remaining solvent in the fiber and gluten meal can be removed using a conventional de-solventizing device 63 such as, but not limited to a centrifuge or evaporator, and can be dried.

The sugar syrup proceeds to a fermentation device 54 for fermenting the sugar syrup in the presence of a micro-organism that can ferment the sugar to produce a fermented product such as yeast and distilling the fermented product to produce a distilled product in a distillation device 55. The fermentation step produces beer and carbon dioxide. The carbon dioxide can be reduced using a conventional carbon dioxide scrubber 54a or captured as a co-product. The distilling step can also produce a distilling residue that can be recycled back into the second mixture in the slurry tank 52.

The distilled product can comprise ethanol and water and preferably comprises at least 95% ethanol and about 5% water. The water can be removed from the distilled product using a molecular sieve 56 to produce anhydrous ethanol as described above. A denaturant can be added to the ethanol to denaturalize 47 the ethanol The illustrative embodiment for sugar syrup product shown in FIG. 4 can comprise placing the second mixture in a slurry tank 72 and adding an enzyme for hydrolysis of starch such as, but not limited to gluco-amylase, pullulanase, and maltase. The second mixture can be heated to a superambient temperature in the range of about 85° to about the boiling temperature of the second mixture and the enzyme can be added thereto. Heating the slurry can accelerate the starch dispersion process and leach out any entrapped grain solids. Heating can be extended to produced the desired value of the dextrose equivalent (DE). The heating allows the residual alpha-amylase to further hydrolyze the starch to the desired DE value before the second mixture goes through further processing. The heating and adjusting of the pH of the mixture in the slurry tank is determined according to the specifications of the enzyme used.

The second mixture can then proceed to a separating device 73 for separating the fiber from the gluten and oil. The fiber can then be dried in a dryer 65 to produce the fiber product.

The gluten and oil can be further separated using a conventional solvent extraction device 66 to leave a sugar syrup. The solvent can then be removed from the oil using evaporation in a conventional evaporation device 67 to produce the oil product. Conventional evaporation 68 equipment and method can be used to remove any solvent from the gluten meal. The gluten meal can be further processed by in a dryer 69 to produce the final gluten meal product.

The sugar syrup can be purified 74 using conventional techniques to remove any impurities and to produce the sugar syrup products such as glucose, maltodextrin, dextrose, and high fructose corn syrup.

The following examples are offered in order to more fully illustrate the invention but is not to be construed as limiting the scope thereof.

### EXAMPLE 1

A two-inch twin-screw high-shear processor (Readco Manufacturing Company, York, Pa.) was used for feasibility studies. A five-inch twin-screw processor also was provided by the Readco Manufacturing Company. Corn kernel and corn gluten meal were processed according to the flow diagram (FIG. 1). For whole corn kernel, two controls were prepared. One set of control samples were processed without addition of alpha-amylase, and the other set of control samples were processed without high temperature but with high shear.

In extraction experiments, 1,000 g of sample was placed in a column (5 cm in diameter, and 65 cm in length) jacketed with hot water at 65° C. to 75° C. After two hours, the temperature of the samples was equilibrated, and 1,300 ml of 95% ethanol was pumped to the top of the column and elution started. Approximately 1,000 ml of eluant was collected, and the rest of the solvent was entrapped in the corn residue. The extractant was cooled to ambient temperature. Upon cooling, some of the corn-oil complex precipitated, and the solution and precipitate were evaporated in a vacuum rotary evaporator. The oil in the protein fraction was further extracted with hexane. The yield of corn oil and corn protein were determined after evaporation of solvents.

The sample treated with alpha-amylase was extracted with 8% yield and included approximately 4% corn oil and 4% corn protein. The process altered the solubility of protein. At a temperature above 65° C., corn oil and corn protein were extracted simultaneously. The protein concentration in the hot solvent was approximately 4%. The solubility of this processed material was at least 10 times higher than the zein in natural state.

The control samples, without addition of alpha-amylase had approximately 4% yield, including 2.5% of protein and 1.5% of corn oil. The other control samples, without application of high temperature in the processor, had further decreased the yield to approximately 2%, including approximately 1% of corn oil and 1% of corn protein.

When corn gluten meal obtained from a wet milling process was used as a raw material, alpha-amylase was not used because there was no residual starch. The yield of the treated sample was approximately 25%, including 2.5% corn oil. Since corn gluten meal does not contain enough oil to form a complex with zein, the yield of extraction is small.

In fact, after the removal of zein, the residual corn gluten meal had a more balanced protein/lysine ratio that would be beneficial to animals. In the control sample without application of high temperature, the yield was only 5%.

The extracted protein was thermoplastic in nature. Its melting point was approximately 50° C.

### EXAMPLE 2

25 ml of alpha-amylase (Spezyme Fred) from Genencor and 1,500 ml of water was mixed with 5 kg of corn and the mixture was fed into a 2-inch continuous processor at a rate of 70 g per minute; the steam pressure in the steam jacket was 90 psi; and RPM of 100. The processing provided a reduced moisture product in the form of powder had a moisture content of approximately 6%.

1000 g of the reduced moisture product was placed in an extractor column (5 cm in diameter, and 65 cm in length) jacketed with hot water at 68° C. 1,300 ml of ethanol (65 C) was fed from the top of the extractor column. 1000 ml of eluent was collected at a rate of 20 ml per minutes. The residual material in the column was de-solventized by passing compressed air through the column (ethanol was not recovered). The eluent was evaporated using a vacuum rotary evaporator. 87 g of the residual material was obtained. The oil in the residual material was then extracted twice with 250 ml of hexane. Approximately 44 g of corn oil was obtained after hexane was evaporated from the extract.

The de-solventized residual material was mixed with 2200 ml of water in a beaker to form slurry and heated to 95° C. for 30 minutes. After cooling to 65° C., the pH of the slurry was adjusted to 4.75 and 1 ml of glucoamylase from Novozymes was added to the slurry. After the slurry was maintained at 65° C. for five hours, the slurry was further adjusted to pH 6.8 and heated to 95° C. for two minutes. The slurry was then poured on a screen (200 mesh) to remove fibers. The fiber on the screen was washed with 100 ml of water three times. The washing water was combined with the liquid passed through the screen. The liquid was further filtered using a vacuum filter to remove gluten. The filter cake was washed with 100 ml water. Approximately 2400 ml of filtrate was collected. The sugar concentration of the filtrate was approximately 24 brix.

The filtrate was placed in a fermentor and 10 ml of yeast culture was added to it. After 24 hours, the beer contains approximately 11.5% w/w ethanol. The beer was placed in a distillation device to remove the ethanol. Approximately 380 ml of aqueous ethanol was obtained. The residual distillage (2100 ml) was recycled to form a slurry with de-solventized residual material.

The embodiments of the invention can improve the processing of starchy materials processed for food and non-food uses. Such embodiments can preferably have one or more of the following advantages over prior art:

Advantages of the Invention over the Wet Milling Procedure and Equipment

The invention uses a high shear processor 11, 41, 51, 71, 81 as the initial production process to mill, mix, gelatinize, and liquefy the corn. In contrast, the wet milling method uses steeping and grinding as the initial production process to mill the corn.

The inventions requires less equipment and less steps to reach the fermentation step of ethanol production. For example, the embodiment shown in FIG. 1 has five steps, FIG. 4 has three steps, and FIG. 5 has only two steps to reach the fermentation step. While the wet milling ethanol processing requires the following steps and equipment needed therefore: steeping 801, grinding screening 802, de-germ mill 803, liquid cyclone separation 804, washing 805, grinding 806, screen 807, centrifuge 808, starch washing filter 809, slurry tank, 811, jet cooker 812, slurry tank 813, and saccharification 814.

The embodiments of the invention shown in FIGS. 1-4 also eliminate the wet milling's fifth co-product branch to produce the distiller grain requiring the centrifuge 820, evaporator 821, and drying 822 equipment. By eliminating the centrifuge and dryer equipment as the final production process of producing distiller grain, the invention eliminates the air pollutants and smelly odor problem caused by the production of distiller grain under the wet milling method.

Since numerous wet milling steps and equipment are eliminated by processing pursuant to this invention, this invention advantageously requires less capital investment cost than wet milling. The capital equipment cost of the invention is estimated to be less than half that required for a 50 million gallon wet milling ethanol plant.

Furthermore, even the fermentation 16, 54 and distillation 17, 55 steps of the embodiments of invention shown in FIGS. 1 and 3 are different from the fermentation 815 and distillation 816 steps in wet milling. The throughput to the fermentation 16, 54 and distillation 17, 55 steps does not contain grain solids because distiller grain is not part of the throughput. While the fermentation 815 and distillation 816 steps of wet milling carry the grain solids (from the addition of corn steep liquor) for the production of the distiller grain, which is then separated from the ethanol after distillation 816.

The invention can reduce the water input by as much as 95%, waste water output by as much as 90%, and electricity usage by as much as 47% when compared to wet milling.

The invention can yield 2.85 gallons of ethanol per bushel of corn, which is more than the ethanol yield of 2.45 gallons per bushel of corn for wet milling.

The invention also eliminates the steeping 801 step as the initial production process for wet milling and the use of SO₂ into steeping. Thus, the problems of SO₂ emission as air pollutants and a smelly odor problem are completely eliminated by this invention.

The wet milling method of ethanol can produce five co-products: corn oil, corn oil meal, steep liquor, gluten meal, fiber, and distillers grain. The invention can eliminate distiller grain and corn steep liquor as a co-product and the equipment needed for processing the distillers grain. The invention can advantageously eliminate the air pollution produced during the distillers grain processing and the capital investment required for the distillers grain processing.

Advantages of the Invention Over Dry Milling Procedure and Equipment

The dry milling method shown in prior art FIG. 10 illustrates that the dry milling method for ethanol production and requires the use of a hammer mill, slurry tank, and jet cooker for the initial production process. This invention, however, only uses a high shear processor 11, 41, 51, 71, 81 as the initial production process. The high shear processor used pursuant to the invention achieves milling, mixing, gelatinization, and liquefaction of the starchy material in one piece of equipment.

The invention eliminates the capital investment needed for the hammer mill, slurry tank, and jet cooker, which consumes more than one third of total capital investment in the dry mill plant.

In addition, the equipment needed to produce the various co-products prior to the fermentation process for this invention costs no more than the dry milling distiller grain processing equipment. For example, an evaporator 21, extractor 22, evaporator 23, fiber drier 31, and gluten meal drier 32 are shown in the FIG. 1 and provide oil, zein, fiber, and gluten meal as co-products. The equipment cost needed to produce the various co-products in this invention is no more than the cost of a centrifuge 920, evaporator 921, and dryer 922 used to produce distiller grain in dry milling.

The processing steps can be different from the dry milling method. For example, the embodiment shown in FIG. 1 begins with application of shear force in the processor 11 to mill, mix, gelatinize, and liquefy the starchy material and water; extraction; de-solventization; and saccarification prior to fermentation. The dry milling method requires the following steps prior to fermentation: milling by a hammer mill, soaking in a slurry tank, jet cooking for gelatinization, liquefaction in a liquefaction tank, and mash cooking.

The embodiments of the invention shown in FIGS. 1-4 do not produce a smelly odor like that produced in the dry grinding method processing of distiller grain.

The invention can also provide a savings in capital investment as the invention provides a 30% less throughput capacity at the fermentation step. The entire kernel goes into the fermentation tank, in contrast, this invention can have no grain solids in the fermentation tank. The fermentation mixture in the dry milling method contains distiller grain solids that can occupy about 30% of the volume of the liquid fed into the fermentor. This invention separates the zein, oil, fiber and gluten meal prior to the fermentation and distillation steps to reduce the throughput therein. Furthermore, the distillation step of the invention can have only one-half of the throughput capacity of the dry milling distillation equipment. The reduced throughput at the fermentation and distillation stages of the invention provides a lower operating cost and capital investment when compared to the dry milling fermentation and distillation steps.

In addition, the invention can further reduce costs by recycling the distilling residue back into the second mixture. In the dry milling method, the liquids must be separated at the distillation step 907, which may need to be separated by centrifuge and dried. The capital cost of this post-distillation equipment can be approximately 39% of the total equipment cost of the dry milling ethanol plant. This invention can eliminate the need for this equipment.

Most dry milling ethanol plants produce distiller grain as their chief co-product, which is processed after fermentation and as the last step of production. The distillers grain has a low economic value and is used primarily for animal feed production. In contrast, the invention can produce ethanol along with food or pharmaceutical grade co-products such as, but not limited to, oil, carotenoids, protein, fiber, gluten meal, and mixtures thereof. Also, the invention's co-products are produced prior to the fermentation process.

Furthermore, as discussed above, the production of distillers emits a large amount of air pollution and smell odor. Since the invention can eliminate distiller grain as a co-product, a large amount of air pollution produced by the equipment used to process the distiller grain can be eliminated. The invention can also eliminate the smelly odor released during production and storage of the distillers grain.

Advantages of the Products Produced in this Invention

The invention can produce starch, ethanol, or sugar syrup as the chief product and can produce several food-grade co-products like oil, protein, fiber, and gluten meal.

For example, when corn is processed pursuant to the embodiment of the invention shown in FIG. 1, the co-products can comprise corn oil with carotenoids, zein, fiber, gluten meal, and carbon dioxide. These co-products are produced prior to the fermentation step 16 and comprise the following percentages of corn input:

| | % of Corn Input |
|---|---|
| Zein (food and pharmaceutical grade) | 3.80% |
| Corn oil with high level of carotenoids | 4.35% |
| Corn gluten meal with good nutritional value | 3.50% |
| (food grade) | |
| Corn Fiber of food or industrial grade with no | 12.30% |
| residual starch | |
| Total of the four co-products | 23.95% |

The values of these co-products are several times the typical price of distiller grain produced using the dry or wet milling methods. In May 2006 the price of corn oil is estimated at about $600 per ton; corn gluten meal is estimated at about $265 per ton; corn fiber is estimated at about $58 per ton; and zein should command a higher price than even the corn oil. The total revenue of these four co-products is much greater than the price of the distiller grain, which is estimated at only $88 per ton.

Environmental Impact

There are concerns, as described above, over the wet and dry milling emissions of sulfur dioxide, VOCs, carbon monoxide, NOx, PM, HAPs and/or smelly odors at the various steps of processing. The invention completely eliminates the emission of sulfur dioxide since there is no steeping step required. The invention can also eliminate distiller grain as a co-product, which can also eliminate the large amount of air pollution and smelly odor released during distiller grain processing.

The invention can reduce the emission of VOCs and PM because the invention can capture the oil and protein as co-products instead of burning them and sending the emissions as air pollutions as in the dry milling method.

Furthermore, some of the equipment that generates emissions in the dry and wet milling method can be eliminated in this invention. For example, the centrifuge 820, 920 and drier 821, 922 are not required for this invention. Although some VOCs can be generated at some stages of the invention, the total VOC and PM emission can be less than the dry and wet milling methods.

In addition, the invention can also reduce consumption of natural and power resources. For example, the invention can use around 95% less water than the wet milling method requires; and reduce electric usage by as much as 47% when compared to the wet milling method. The invention can advantageously use a high shear processor for several steps of processing a starchy material, which can advantageously reduce the processing time from milling to starch liquefaction to as little as two minutes. The reduced processing time can also reduce the amount of natural resources typically required during the initial steps of the conventional dry and wet milling methods.

It is to be understood that the invention has been described with respect to certain specific embodiments thereof for purposes of illustration and not limitation. The present invention envisions that modifications, changes, and the like can be made therein without departing from the spirit and scope of the invention as set forth in the following claims.

What is claimed is:

1. A method of processing a starchy material comprising the steps of:
(a) introducing a starchy material and water into a high shear processor; and
(b) applying such a force to the material that is at a superambient temperature within the processor to mill, mix, and gelatinize some of the starch of the starchy material, thereby producing a processed product.

2. The method according to claim 1 wherein said starchy material is corn, sorghum, millet, rice, oat, wheat, barley, buckwheat, rye, sweet potato, potato, cassaya, starch, or mixtures thereof.

3. The method according to claim 1 wherein said water is introduced into the high shear processor to achieve a liquid content in the range of about 20% to about 80% w/w of the starchy material and water.

4. The method according to claim 1 wherein the superambient temperature in a range from about 80° C. to about 150° C.

5. The method according to claim 1 wherein a heating device is provided around the high shear processor for providing the superambient temperature.

6. The method according to claim 1 wherein the processor comprises a high shear processor having one or more rotating shafts with one or more paddles for applying force.

7. The method according to claim 6 wherein the high shear processor has two shafts with paddles for applying force.

8. The method according to claim 1 wherein step (a) further comprises introducing a liquefaction enzyme into the high shear processor to liquefy the processed product.

9. The method according to claim 8 wherein said liquefaction enzyme is alpha-amylase.

10. The method according to claim 1 further comprising reducing the moisture of the processed product to produce a reduced moisture product.

11. The method according to claim 10 wherein the reduced moisture product is powder, flakes, chunks, or mixtures thereof.

12. The method according to claim 10 wherein the reduced moisture product and water at a subambient, ambient, or superambient temperature form a highly viscous paste that has a viscosity greater than that of distilled water.

13. The method according to claim 10 wherein said reducing the moisture occurs in the high shear processor.

14. The method according to claim 10 further comprising a reduced moisture product having a moisture content of about 70% w/w or less.

15. The method according to claim 10 further comprising a reduced moisture product having a moisture content of about 10% w/w or less.

16. The method according to claim 15 comprising the further step of contacting the reduced moisture product with ethanol and water to remove water from the ethanol.

17. The method according to claim 10 comprising the further step of contacting a liquid extractant and the reduced moisture product to form a first mixture comprising:
a) an alcohol extractable product comprising oil and an alcohol soluble protein; and
b) a residue product comprising fiber, gluten, and starch.

18. The method according to claim 17 comprising the further step of separating the alcohol extractable product from the residue product using the liquid extractant.

19. A method according to claim 17 wherein the liquid extractant is ethanol, isopropanol, water, or mixtures thereof.

20. A method according to claim 17 wherein said liquid extractant comprises about 85% to about 100% w/w ethanol.

21. A method according to claim 17 wherein the liquid extractant is in a temperature range of about 50° C. to about 78° C.

22. The method according to claim 18 comprising the further step of removing the liquid extractant from the alcohol extractable product.

23. The method according to claim 22 comprising the further step of separating some of the oil from the alcohol soluble protein leaving a further product comprising an alcohol soluble protein and oil.

24. The method according to claim 23 wherein the further product is soluble in about 85% to about 100% w/w ethanol.

25. The method according to claim 23 wherein the alcohol soluble protein is zein, kafirin, or a mixture thereof.

26. The method according to claim 23 wherein the alcohol soluble protein is thermoplastic.

27. The method according to claim 23 wherein the oil comprises one or more carotenoids.

28. The method according to claim 27 wherein the carotenoid is lutein, zeaxanthin, lycopene, or mixtures thereof.

29. The method according to claim 27 wherein the oil contains a minimum of 250 ppm of carotenoids.

30. The method according to claim 18 comprising the further step of reducing the amount of the liquid extractant in the residue product.

31. The method according to claim 30 wherein the amount of liquid extractant in the residue product is in a range from about 0.4 to about 2.0 kg per ton of residue product.

32. The method according to claim 30 comprising the further steps of forming a second mixture comprising the residue product and water and heating the second mixture to a superambient temperature in the range of about 85° C. to the boiling temperature of the second mixture.

33. The method according to claim 27 wherein the second mixture has a residue product to water ratio in the range of about 1 to about 2.0 to about 1 to about 4.0.

34. The method according to claim 32 comprising the further step of separating the fiber and the gluten from the second mixture leaving a sugar syrup to be processed.

35. The method according to claim 34 comprising the further step of removing impurities from the sugar syrup.

36. The method according to claim 34 comprising the further step of drying the fiber, the gluten, or mixtures thereof.

37. The method according to claim 32 comprising the further step of adding a saccharification enzyme to the second mixture to saccharify the starch into a sugar syrup, and adjusting the pH and temperature of the second mixture for the saccharification enzyme.

38. The method according to the claim 37 wherein the saccharification enzyme is glucoamylase, pullulanase, or mixtures thereof.

39. The method according to claim 37 comprising the further step of separating the fiber and the gluten from the second mixture leaving a sugar syrup to be processed.

40. The method according to claim 39 comprising the further step of drying the fiber, the gluten, or mixtures thereof.

41. The method according to claim 37 comprising the further steps of adjusting the pH of the second mixture above 6.8, heating the second mixture to about 80° C. to about boiling temperature of the second mixture, separating the fiber and the gluten from the second mixture leaving a sugar syrup to be processed, and drying the fiber, the gluten, or mixtures thereof.

42. The method according to claim 37 comprising the further step of fermenting the sugar syrup in the presence of a micro-organism that can ferment the sugar to produce a fermented product, and distilling the fermented product to produce a distilled product that comprises ethanol and water.

43. The method according to claim 42 wherein the fermented product comprises beer and carbon dioxide.

44. The method according to claim 42 wherein the distilled product comprises at least 95% w/w ethanol and about 5% water.

45. The method according to claim 42 comprising the further step of removing the water from the distilled product to produce anhydrous ethanol.

46. The method according to claim 45 comprising the further step of adding denaturant to the anhydrous ethanol.

47. The method according to claim 42 wherein the distilling step also produces a distilling residue and recycling the distilling residue back into the second mixture.

48. Ethanol made by the process according to claim 46.

49. A method of processing a starchy material to produce ethanol comprising the steps of:
a) introducing water, a starchy material, and a liquefaction enzyme into a high shear processor;
b) applying such a force to the material that is at a superambient temperature within the processor to mill, mix, gelatinize some of the starch of the starchy material, and liquefy, thereby producing a processed product;
c) reducing the moisture of the processed product to produce a reduced moisture product;
d) contacting a liquid extractant and the reduced moisture product to form a first mixture comprising:
i) an alcohol extractable product comprising oil and an alcohol soluble protein, and
ii) and a residue product comprising fiber, gluten, and starch;
e) separating the alcohol extractable product from the residue product using the liquid extractant;
f) reducing the amount of the liquid extractant in the residue product;
g) forming a second mixture comprising the residue product and water and heating the second mixture to a superambient temperature;
h) saccharifying some of the starch in the second mixture at a superambient temperature;
i) separating the fiber and the gluten from the second mixture leaving a sugar syrup to be processed;
j) fermenting the sugar syrup in the presence of a micro-organism that can ferment the sugar to produce a fermented product that comprises beer and carbon dioxide, and distilling the fermented product to produce a distilled product that comprises ethanol and water;
k) removing the water from the distilled product to produce anhydrous ethanol; and
l) adding a denaturant to the anhydrous ethanol.

48. A starchy material processing system comprising a) a high shear processor that receives a starchy material and water for milling, mixing, and gelatinization of some of the starch of the starchy material;
b) a first extractor having an extractant that can separate an alcohol extractable product comprising a protein and oil and a residue product comprising gluten, and starch;
c) a de-solventizer device to reduce residual extractant in the extracted residue;
d) a slurry tank to mix water and extracted residue at a superambient temperature to form a second mixture comprising fiber, gluten, and sugar syrup; and
e) a separator device for separating fiber and gluten from the sugar syrup.

49. The processing system according to claim 48 further comprising a drier to dry the fiber, gluten or a mixture thereof.

50. The processing system according to claim 48 further comprising an evaporator device to remove the extractant from the alcohol extractable product and a second separator device to separate the protein and oil in the alcohol extractable product.

51. The processing system according to claim 48 further comprising:
a) a fermentation device for fermenting the sugar syrup with a micro-organism that can ferment the sugar to produce a fermented product;
b) a distillation device for distilling the fermented product comprising ethanol and water;
c) a second separator device for separating the water from the ethanol to produce anhydrous ethanol; and
d) a mixing device for adding denaturant to the anhydrous ethanol.

52. A method of processing a starchy material comprising the steps of:
a) introducing a starchy material, liquefaction enzyme, and water into a high shear processor;
b) applying shear force to the material at a superambient temperature within the processor to mill, mix, gelatinize some of the starch of the starchy material, and liquefy, thereby producing a processed product;
c) reducing the moisture of the processed product to produce a reduced moisture product comprising oil, protein, fiber, gluten, and starch; and
d) forming a second mixture comprising the reduced moisture product and water.

53. The method according to claim 52 comprising the further step of separating fiber, gluten, and the oil from the second mixture leaving a sugar syrup to be processed.

54. The method according to claim 53 comprising the further step of separating the oil from the gluten and fiber, and drying the gluten and fiber.

55. The method according to claim 53 comprising the further step of separating the fiber, oil, and gluten from the second mixture leaving the sugar syrup to be processed.

56. The method according to claim 55 comprising the further step of drying the fiber, gluten, or mixtures thereof.

57. The method according to claim 53 comprising the further steps of:
a) saccharifying some of the starch in the second mixture at a superambient temperature leaving a sugar syrup to be processed;
b) fermenting the sugar syrup in the presence of a micro-organism that can ferment the sugar to produce a fermented product, and
c) distilling the fermented product to produce a distilled product that comprises ethanol and water.

58. The method according to claim 57 wherein the distilled product comprises at least 95% ethanol and about 5% water.

59. The method according to claim 58 comprising the further step of removing the water from the distilled product to produce anhydrous ethanol.

60. The method according to claim 59 comprising the further step of adding denaturant to the anhydrous ethanol.

61. The method according to claim 57 wherein the distilling step also produces a distilling residue and recycling the residue back into the second mixture.
